(19) United States
(12) Patent Application Publication
(10) Pub. No.: US 2008/0236511 A1
(43) Pub. Date: Oct. 2, 2008

(54) PROGRAMMABLE PET TOY

(75) Inventors: Jim Boelke, Neenah, WI (US); John Galkiewicz, Harrogate, TN (US)

Correspondence Address: GODFREY & KAHN S.C., 780 NORTH WATER STREET, MILWAUKEE, WI, 53202, US

(73) Assignee: Cat Dancer Products, Inc.

(21) Appl. No.: 12/044,749

(22) Filed: Mar. 7, 2008

Related U.S. Application Data
(60) Provisional application No. 60/894,142, filed on Mar. 9, 2007.

(51) Int. Cl. A01K 29/00

(52) U.S. Cl. 119/707

(57) ABSTRACT

A programmable pet toy, where the movement of the toy or an object of interest attached or connected to the toy is automated, and the operation of the toy can be programmed by the pet owner to operate at desired time intervals or after predetermined time delays to provide automated amusement for a pet. The toy may further include devices for making sounds to attract the attention of a pet, and objects of interest that can be replaced by alternate objects.

### PRIORITY INFORMATION

This application claims the benefit of provisional U.S. Application No. 60/894,142, filed Mar. 9, 2007, which is specifically incorporated herein by reference under 35 U.S.C. § 119(e).

### FIELD OF THE INVENTION

This invention relates generally to the field of pet toys. More specifically, it relates to a pet toy which is automated to provide amusement for a pet by including a moving object and sounds.

### BACKGROUND OF THE INVENTION

Toys are well known for providing amusement to pets. One such toy is disclosed in U.S. Pat. No. 5,542,376 to Udelle et al. Udelle et al. teaches an animal amusement and exercise device wherein an object is attached to a rotating arm, and a cover has holes under which the object moves and wherein the animal may place its paw to touch the object when visible. A limitation on this system is that the moving object moves only in a circle, fails to include sounds with which to attract animals, and cannot be programmed to operate at desired times.

Other such toys are disclosed in U.S. Pat. No. 6,892,675 to Comerford and U.S. Pat. No. 6,039,628 to Kusmiss et al. Comerford teaches a cat toy wherein a motor assembly on a support structure rotates an elongated member to which an object of interest to the cat is attached, such that the object of interest moves about the central axis of the support structure to attract the attention of the cat. Kusmiss et al. teaches a self-mobile cat toy with an electrical power source connected to motor-powered wheels or a tread mechanism to allow the cat toy to move along the ground. However, both of these systems fail to provide the capability of programming the toys to operate at desired time intervals or after a desired time delay, meaning the pet owner using either of these prior art systems would be required to be present to turn the respective toys on and off.

The existing pet toys do not allow a pet owner to program the toy to operate at a desired time or desired time intervals. Existing toys do not lend themselves to a compact overall design capable of housing multiple amusement features, and do not provide enhanced amusement features such as sound, replaceable moving objects, disappearance and reappearance of a moving object, and ease of securing the toy to a door for placement on multiple floor surfaces.

Accordingly, a need exists for a pet toy in which an owner can program the automated toy to operate at desired times, and which incorporates a variety of amusement features.

### SUMMARY OF THE INVENTION

The present invention provides a programmable pet toy. The movement of the toy or an object of interest attached or connected to the toy is automated, and the operation of the toy can be programmed by the pet owner to operate at desired time intervals.

In one embodiment, the toy includes a base with a prime mover, such as a motor or rotating gear by which an object moves. A control selectively powers the prime mover according to input from a user, besides by instant activation, by programming either via a timer to activate the toy at desired time intervals or after a desired time delay. The electronics, track gearing, and power sources for the toy can be held within the base and within a number of items mounted on the base. The invention may also include an object of interest which is replaceable. In one embodiment of the present invention, the object is a toy mouse. The invention may incorporate sounds to attract the attention of a pet. The invention may also allow the object to appear and disappear behind or within the items mounted on the base. The invention may further include a platform to allow the user to secure the toy to a door and a guard on the back wall to prevent the pet's paws from reaching behind the toy or from moving the toy.

In another embodiment, a base includes a prime mover, such as a motor, an elongated arm connected to the prime mover, and an attached object of interest at the opposite end of the arm. The motor rotates or otherwise moves the arm to move the object to attract the attention of a pet. A control selectively powers the motor according to input from a user, by instant activation and by either programming via a timer to activate the toy at desired time intervals or after a desired time delay or both.

In yet another embodiment, an object of interest is self-movable and includes a power source connected to motor-powered wheels or a tread mechanism to allow the object to move along the ground. A control selectively powers the motor according to input from a user, by instant activation and by either programming via a timer to activate the toy at desired time intervals or after a desired time delay.

The present invention has several advantages and benefits over the prior art. Other objects, features and advantages of the present invention will become apparent after reviewing the following detailed description.

### BRIEF DESCRIPTION OF THE DRAWINGS

FIG. 1 is an front view of one embodiment of a programmable pet toy in accordance with the present invention.

FIG. 2 is an upper perspective view of the embodiment shown in FIG. 1.

FIG. 3 is a cross-sectional view of the embodiment shown in FIG. 1, taken along line 3-3 thereof.

FIG. 4 is a cross-sectional view taken of the embodiment shown in FIG. 1, taken along line 4-4 thereof.

FIG. 5 is a rear perspective view of the embodiment shown in FIG. 1.

FIG. 6 is a detail cross-sectional view of a stanchion and thumbscrew securing one embodiment of a programmable pet toy in accordance with the present invention to a door.

FIG. 7 is a perspective view of another embodiment of programmable pet toy in accordance with the present invention.

FIG. 8 is a side view of another embodiment of a programmable pet toy in accordance with the present invention.

### DETAILED DESCRIPTION OF THE PREFERRED EMBODIMENTS

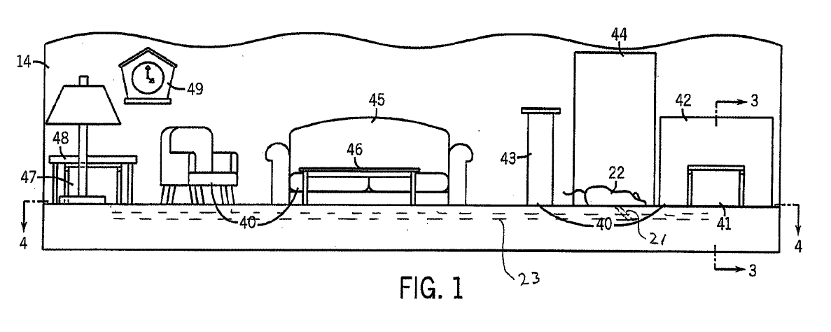

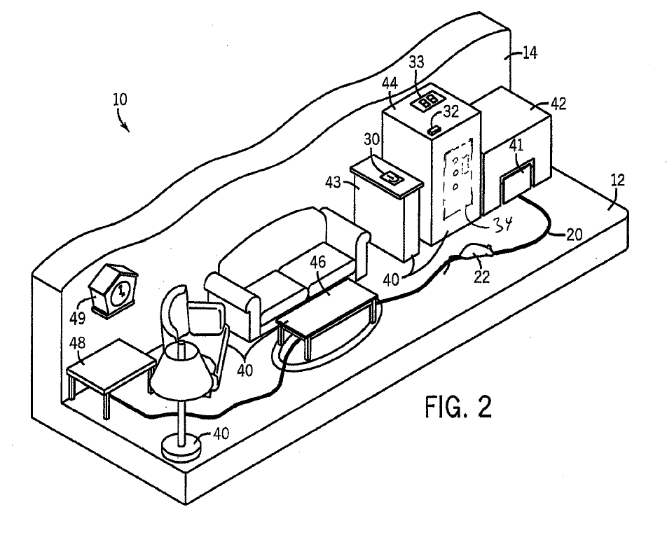

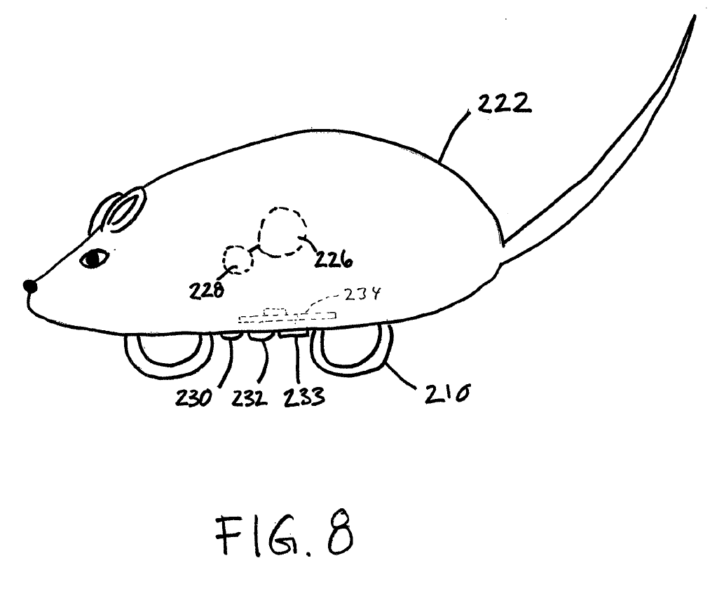

Referring now to the drawings, FIGS. 1-6 are views of one embodiment of a programmable pet toy 10 in accordance with the present invention. In this embodiment, the toy 10 includes a base 12 and optionally a back wall 14. The base 12 is formed with or has mounted thereon a track 20, along which an object of interest 22 can move. The movement of the object 22 along the track 20 simulates an object moving along the ground or floor, designed to attract a pet, such as a cat, ferret, and so on, to chase the object. The object 22 is attached by means of a suitable link 21 to a flexible drive member 23 (both shown in phantom in FIG. 1), such as a belt or chain, within the track 20.

The link 21 connecting the object 22 with the flexible drive member 23 may be flexible so that it is possible for the pet to impede or stop the object's progress without damage the object 22 or track 20, but it must be attached securely enough so that the pet cannot remove the object 22 from the toy 10 completely. The track 20 can be designed to allow the object 22 to continue along the track 20 by providing continuous persistent resistance to anything that impedes the object's 22 progress, thereby allowing the pet to momentarily slow the object 22 down, but not stop the object 22 completely. The speed and steadiness of the movement of object 22 can be varied to increase or decrease the amount of movement that will best attract the animal for which the toy 10 is to be used. In one embodiment of the present invention, the object 22 may have a shape to be of interest to particular pets for which the toy may be designed, for example as shown in the embodiment in FIGS. 1-4, a mouse or bird for use with a toy for cats.

The object 22 may also be made more attractive to a pet by constructing it of various types of materials, including by not limited to natural materials such as leather, faux or real fur, wool, feathers, etc. and be scented, for example with catnip, to make it more appealing to the pet. In one embodiment of the present invention, multiple objects 22 can be utilized. The object 22 and track 20 may also be designed such that the user can replace the object 22 as it becomes worn from pet play. The motor and gearing for the track 20 may be designed to produce as little sound as possible to as to not distract the pet with mechanical sounds. Alternatively, or at the same time, the toy 10 can be designed to produce sounds specifically selected to alert the pet that the toy 10 has been activated.

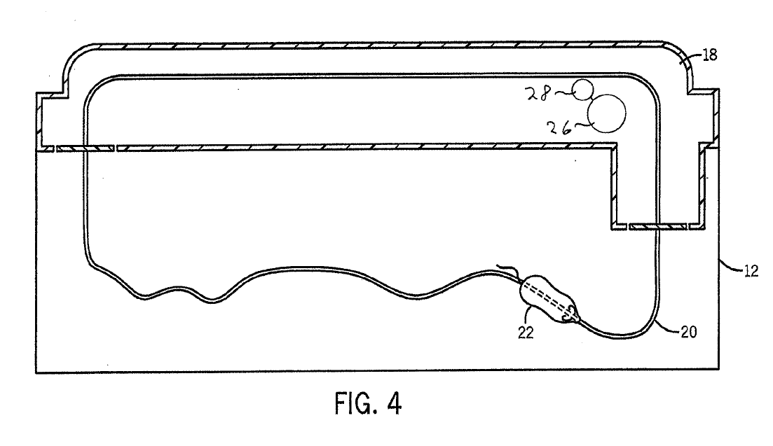

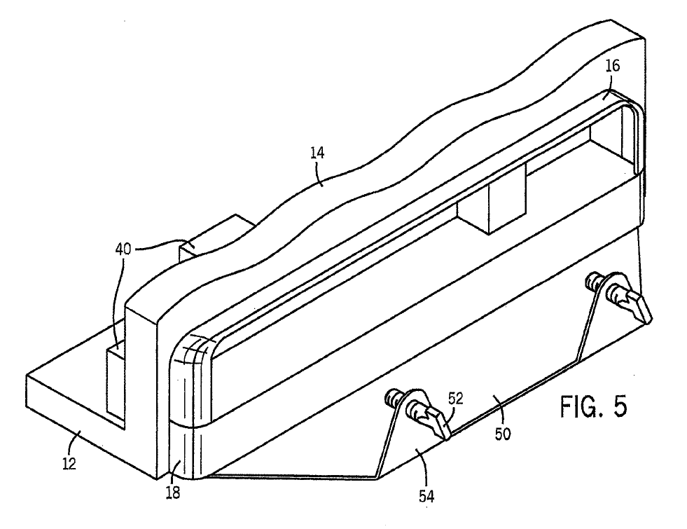

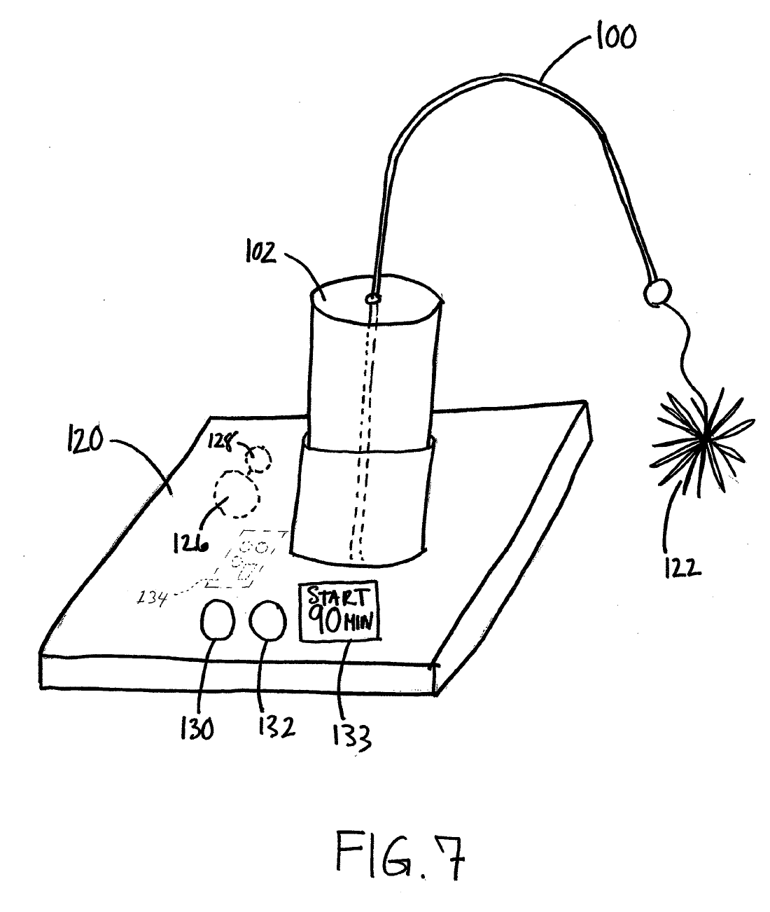

The movement of the object 22 along the track 20 is brought about by any suitable prime mover 26, such as an electric motor, powered by batteries or AC power, or both, and connected to the flexible drive member 23 by any suitable transmission and/or gearing arrangement 28, shown schematically in FIG. 4. The motor 26 is controlled by a suitable control 34, shown in phantom in FIG. 1, which is preferably an electronic control. The user can activate the movement of the object 22 by pushing a power button 30 located on the toy 10 connected to the control 34. The movement/action sequence of object 22 can commence immediately upon pushing of the power button 30. This button can be located in various positions on the toy 10 or items 40 on the toy. As shown in the embodiment in FIG. 1, the power button 30 is the top portion of a wall 43 located on the base 12, and is easily accessible for activation by the owner. Additionally, by pushing a timer button 32 located on the toy 10, the user can add time to the intervals between action sequences, for example one minute, ten minutes, 60 minutes, 90 minutes, etc. Thus the control 34 will cause the toy 10 to self-activate at the desired time interval. The user can therefore program the toy 10 to activate at desired intervals throughout the day, when, for example, he or she is away from the pet. As another alternative, the user can set the control 34 to activate the toy 10 after a desired time delay. An LCD display 33, may be located near the timer button 32 for a readout of the time intervals or time delay selected by the user. In the embodiment shown in FIG. 1, the timer button 32 and LCD display 33 are located on top of one of the items 40, the refrigerator 44, mounted on the base 12, for easy access by the user. One embodiment of the invention may include these two power and programming options, but other configurations and combinations may be used to activate the action sequence of the object 22 along the track 20.

In the embodiment shown in FIGS. 1-6 the base 12 and back wall 14 comprise the main body of the toy 10. The base 12 and back wall 14 can support a number of different items 40 through which the track 20 and object 22 move into, out of, and through. As seen in FIG. 5, the rear of the back wall 14 has a guard 16 to strengthen the back wall 14 and to prevent the pet from reaching its paws completely behind the back wall 14 of the toy. In one embodiment of the present invention, formed as part of the back wall 14 is a tunnel 18 into which the object 22 may enter and remain while the toy 10 is not activated. The track 20 runs through the tunnel 18, forming a complete looped pathway for the movement of the object 20 (FIG. 4).

In one embodiment of the present invention shown, the toy 10 is simply placed on the floor. In the embodiment shown in FIG. 5, the base 12 can be secured to a door using a platform 50 and thumb screws 52 attached to stanchions 54. The platform 50 can be slid under a door 56 and the thumbscrews 52 tightened to hold the toy 10 securely in place. Other methods of securing the platform 50 to a door or other support may also be used. The bottom of the base 12 and platform 50 may be fitted with a smooth plate (not shown) so the toy 10 can slide smoothly on carpet. This would allow the toy 10 to be easily moved along the carpet when attached to a door by the thumbscrews 52. Additionally, adhesive-backed felt pads (not shown) may be provided and secured to the bottom of the base 12 in the event the toy 10 is used on a hard surface floor. This would allow the toy 10 to move easily along the floor while attached to a door without damaging the floor surface. Alternatively, double-sided adhesive may be used to hold the toy 10 to the floor.

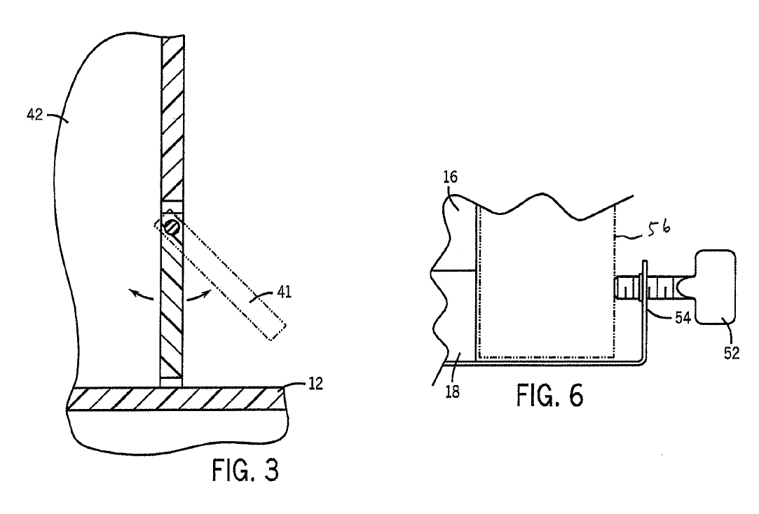

A number of different items 40 and designs or motifs of items 40 may be coupled to the base 12 and/or back wall 14 to provide the environment through which the object 22 moves and overall theme of the toy 10. In one embodiment of the present invention, shown in FIGS. 1-6, a kitchen motif is used for the items 40. The object 22 emerges from the tunnel 18 behind the back wall 14 through a door 41 in a stove 42. The object continues to move along the track 20 and under a center table 46. It then enters another door 47 in the back wall 14 (similar to the door 41) located beneath a side table 48 and enters the tunnel 18 to be out of sight of the pet. The doors 41, 47 are freely movable about a hinge and can swing in forward and rearward directions (FIG. 3) to allow the object 22 to easily pass through the doors 41, 47 with very little force. The movement of the object 22 into, under, and out of the items 40 provides enhanced stimulation for the pet. In addition, the appearance and disappearance of the object 22 from behind the back wall 14 and around the front of the toy 10 provides an added element of amusement for the pet. The items 40 may also be used to house the controls, which may be electronic, as well as motor 26, and power source for the toy 10. For example, in an alternative embodiment to that shown in the FIGS., the refrigerator 44 may house the electronics and motor 26, and the sofa 45 may hold the AC power supply. Alternatively, as indicated above, batteries may be used to power the toy 10 and could also be stored within one of the items 40. Many other variations may be used for the items 40 and overall motif of the toy, as well as other placements of the items 40 with respect to the track 20 and operation of individual items 40 with respect to movement of the object 22. For instance, the motif could be the inside of a barn, the outside of a barn, a forest floor (any type of forest including temperate forest or tropical forest), a desert floor, a warehouse, a science fiction setting, or any other motif that could be imagined. Along the same lines, aspects of the motif, or the entire motif, could be replaceable, so as to provide the pet and its owner with a wide variety of entertainment options.

In an alternative embodiment of a programmable pet toy 10 shown in FIG. 7, an object 122 is attached to a flexible arm 100. The bottom portion of the flexible arm 100 is housed in a housing member 102, and the arm 100 is coupled to a prime mover 126 housed in the base 120. When the toy 10 is activated, the prime mover 126 rotates the arm 100, which causes the object 122 to move in various directions. The movement of the arm 100 is brought about by any suitable prime mover 126, such as an electric motor, powered by batteries or AC power, or both, and connected to the arm 100 by any suitable transmission and/or gearing arrangement 129, shown in phantom in FIG. 7. The motor 126 is controlled by a suitable control 134 which is preferably an electronic control. The user can activate prime mover 126 which activates the movement of the arm 100, which in turn causes movement of the object 122 in various directions by pushing a power button 130 located on the toy 10 connected to the control. The movement of the object 122 can commence immediately upon pushing of the power button 130, or, the user can add time to the intervals between activation of the arm 100 or can set the control to activate the toy 10 after a desired time display by any suitable means, such as by pushing a timer button 132 located on the base 120. An LCD display 133 may be located near the timer button 132 for a readout of the time intervals or time delay selected by the user. The object 122 may be of varying shapes and materials suitable to attract a pet, or may be scented with an attractive substance such as catnip. Varying speeds and directions of movement of the arm 100 may also be incorporated into the activation of the toy 10.

In another embodiment of a programmable pet toy 10 shown in FIG. 8, the toy 10 consists of a self-movable object 222 such as a mouse, bird, etc. The movement of the object 222 via one or more motive members 210 (such as wheels or a tread) is brought about by any suitable prime mover 226, such as an electric motor, powered by batteries or AC power, or both, and connected to the motive member 210 by any suitable transmission and/or gearing arrangement 228, shown in phantom in FIG. 7. Energizing the prime mover 226 activates the motive member(s) 210 and moves the object 222. The prime mover 226 is controlled by a suitable control 234 which is preferably an electronic control. The user can activate the movement of the object 222 by pushing a power button 230 located on the toy 10 connected to the control. The movement of the object 122 can commence immediately upon pushing of the power button 130, or, the user can add time to the intervals between activation of the arm 100 or can set the control to activate the toy 10 after a desired time display by any suitable means, such as by pushing a timer button 132 located on the base 120. An LCD display 233 may be located near the timer button 232 for a readout of the time intervals or time delay selected by the user. The object 222 may be of varying shapes and materials suitable to attract a pet, or may be scented with an attractive substance such as catnip. Varying speeds and directions of movement of the object 222 may also be incorporated into the activation of the toy 10.

In addition to the activation of the toy 10, a variety of sounds may be incorporated into the action sequence of the toy 10. For example, sounds may be used to attract the pet to the toy prior to and during activation. Sounds which are attractive to the animal for which the toy 10 is designed can be incorporated, for example chirping or squeaking simulating birds or mice for a toy 10 designed for a cat. Additional sounds corresponding with the items incorporated into the motif may also be added. For example, in the embodiment shown in FIGS. 1-6, the clock 49 on the back wall 14 can make a clock noise when the object 22 passes a designated point on the track 20. Other sounds may be added to the toy 10 to attract the pet and to correspond to the items 40 and motif of each toy.

While the apparatus hereinbefore described is effectively adapted to fulfill the aforesaid objects, it is to be understood that the invention is not intended to be limited to the specific preferred embodiments of programmable pet toy set forth above. Rather, it is to be taken as including all reasonable equivalents to the subject matter of the appended claims.

What is claimed is:

1. A programmable pet toy comprising:
one or more objects of interest to a pet;
a prime mover, connected to the object of interest and capable of moving the object of interest; and
a control for selectively energizing the prime mover, the control having at least one of the following two modes: activation at desired time intervals, and activation after a desired time delay.

2. The programmable pet toy of claim 1, further comprising
a base;
a track, mounted to or formed integrally with the base, on which one or more objects can move; and
a flexible drive member, connecting the prime mover to the object of interest and moving the object of interest along the track when the prime mover is energized.

3. The programmable pet toy of claim 2, further comprising items coupled to the base, wherein the items can accommodate the prime mover and control for operation of the programmable pet toy.

4. The programmable pet toy of claim 2, further comprising a back wall and a tunnel coupled to the back wall into which one or more objects can enter and exit from through the items coupled to the base.

5. The programmable pet toy of claim 1, further comprising an LED screen for display of desired time intervals programmed by the user.

6. The programmable pet toy of claim 2, further comprising a platform coupled to the base for securing the base to a door.

7. The programmable pet toy of claim 6, further including thumbscrews for securing the base to a door.

8. The programmable pet toy of claim 6, further comprising felt pads affixed to the platform for ease of movement along a hard floor surface.

9. The programmable pet toy of claim 1, wherein the one or more objects can be replaced by alternate objects.

10. The programmable pet toy of claim 1, wherein the operation of the programmable pet toy further includes producing sounds.

11. The programmable pet toy of claim 1, further comprising
a base;
an arm, said arm connecting the prime mover to the one or more objects of interest wherein energizing the prime mover moves the arm and the one or more objects of interest.

12. The programmable pet toy of claim 11, wherein the arm is rotated in a circular motion by the prime mover.

13. The programmable pet toy of claim 11, wherein the one or more objects can be replaced by alternate objects.

14. The programmable pet toy of claim 11, wherein the operation of the programmable pet toy further includes producing sounds.

15. The programmable pet toy of claim 11 wherein the speed and direction of movement of the arm can be varied.

16. The programmable pet toy of claim 1, wherein the object of interest further comprises one or more motive members, the motive members connected to the prime mover for moving the object when the prime mover is energized.

17. The programmable pet toy of claim 16, wherein the operation of the programmable pet toy further includes producing sounds.

18. The programmable pet toy of claim 16 wherein the speed and direction of movement of the object of interest by the prime mover can be varied.

19. A programmable pet toy comprising:
a base,
a back wall coupled to the base;
items of interest coupled to the base and back wall;
a track, mounted to or formed integrally with the base, on which one or more objects can move;
an object of interest to a pet, capable of moving along the track;
a flexible drive member, connected to the object of interest and capable of moving the object of interest along the track;
a prime mover, coupled to the flexible drive member and capable of moving the flexible drive member along the track; and
a control for controlling the prime mover, the controller having a mode wherein the one or more objects are activated by instant activation and at least one of the following modes for automated movement of the one or more objects:
wherein the one or more objects are activated at desired time intervals, or wherein the one or more objects are activated after a desired time delay.
